(19) United States
(12) Patent Application Publication
(10) Pub. No.: US 2004/0063006 A1
(43) Pub. Date: Apr. 1, 2004

(54) Optical memory device and process for operating the same

(76) Inventors: Hiroyuki Takahashi, Yokohama-shi (JP); Shigenobu Hirano, Yokohama-shi (JP); Ikue Kawashima, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/609,529

(22) Filed: Jul. 1, 2003

(30) Foreign Application Priority Data
Jul. 1, 2002 (JP) 2002-192767
May 14, 2003 (JP) 2003-135442

(51) Int. Cl. G11B 7/24; G03C 1/735

(52) U.S. Cl. 430/19; 369/101; 369/108; 430/270.16; 430/334; 430/332; 430/270.15; 430/945

(57) ABSTRACT

The present invention relates to an optical memory device and an operating process thereof. The optical memory device have a recording layer containing a photochromic compound and an electron-accepting compound which is a Lewis acid compound having a Lewis acid part and a long chain part having carbon atoms of C12 or more. One aspect of the operating process has a recording step which recording is performed on the optical memory device by irradiating visible light corresponding to the absorption band of the colored photochromic compound for recording using decolorizing, before and after recording, heating treatments are performed to control the decolorizing sensitivity of the photochromic compound, and an erasing step which ultraviolet light is irradiated to the area including the recorded portion in order to uniformly color the recording layer again.

### BACKGROUND OF THE INVENTION

1. Field of the Invention

The present invention relates to a photon mode optical memory device using a photochromic compound as a recording material, and more particularly to an erasable optical memory device which permits repeated recording, reproduction and erasure by optical irradiation.

2. Description of the Related Art

In recent years, there has been increasing demand for a high density, high capacity memory device, and research is being carried out on the development of optomagnetic memory devices or phase change memory devices, as well as the use of photochromic materials as a recording material. A photochromic optical memory device generally comprises a recording layer of an organic thin layer containing a photochromic material, such as a spiropyrane derivative, a fulgide derivative, a diarylethene derivative or the like, formed on a glass or plastic substrate. If necessary, a reflecting layer “3” comprising a metal reflecting layer, such as of aluminum, gold or the like, is formed on the recording layer “2” or between the recording layer “2” and the substrate “1” (FIGS. 1A and 1B). In the case of the optical memory device of FIG. 1A, for example, an image can be read from the transparent substrate side, and in the case of the optical memory device of FIG. 1B, and the image can be read from the substrate surface. In general, the aforesaid photochromic material changes from a colorless state to a colored state which has an absorption band in a visible light region by irradiating with short wavelength light such as ultraviolet light, and returns to the colorless state again by irradiation with visible light. This change is produced reversibly. Herein, the erased state refers to the state among the above two states which has the absorption band on the short wavelength side, and also includes the case where part of the absorption band are in the visible light region so that there is some coloration.

Recording, reproduction and erasure of the photochromic optical memory are also performed using the above phenomena. Whole surface of the recording layer is irradiated with ultraviolet light so as to color it and it is then irradiated with visible light so as to record information, or whole surface of the recording layer is irradiated with visible light so as to put in the decolorized state, and it is then irradiated with ultraviolet light to so as to record information. In the former case, the recording part is in the decolorized state and other parts are in the colored state, whereas in the latter case, the recording part is in the colored state and the other parts are in the decolorized state. In any case, it is irradiated with light of suitable wavelength, and information is read as a contrast difference between the reflected light intensity of the recording part and the other parts. In the former case, erasure is performed by irradiating with ultraviolet light and returning the recording part to the colored state, whereas in the latter case, erasure is performed by irradiating with visible light and returning the recording part to the decolorized state.

However, when the recording is reproduced, irradiation must be performed with light in a wavelength region absorbed by the photochromic compound, and this light decreases the aforesaid contrast difference. As a result, a serious practical problem arises in that the recording may be destroyed, and some proposals have been made in order to prevent this problem.

In Japanese Patent Application Laid-Open (JP-A) No. 01-246538, a different method from that of the absorbance change of the photochromic compound is proposed where the variation in the degree of optical rotation at a long wavelength where there is no light absorption is used for read-out. In backnumber 31H30 of the Proceedings of the 58th Session of the Chemical Society of Japan, Spring 1989 Lecture, a method is proposed where refractive index anisotropy is produced, and this is used for read-out with light in the long wavelength region where there is no light absorption. In these methods, however, the change of optical properties is small, so a problem arises in their practical utilization.

In the Proceedings of the 52nd Session of the Chemical Society of Japan, Spring 1986, a method is proposed for mixing a chiral photochromic compound with a liquid crystal material, and changing the cholesteric liquid crystal phase by photoisomerization. However, the liquid crystal flows with time, so the memory became non-finite, and there was a problem of thermal stability and repeat durability of the memory.

In JP-A No. 01-251344, in order to prevent the time-dependent deterioration accompanying the flow of the liquid crystal, a method is proposed using a polymer liquid crystal as a liquid crystal material, but there are problems, such that perfect erasure of recording is difficult.

The following proposals have also been made.

In JP-A No. 05-216183, in a side chain type liquid crystal polymer film having a photochromic compound as one component, it is proposed to reproduce recordings with light of the wavelength region wherein the photochromic compound does not have absorption using the refractive index change accompanying photoisomerization of the photochromic compound. In JP-A No. 06-49443, the optical response is controlled in a photochromic compound having a site where the conformation can be reversibly controlled by an external stimulus such as a redox reagent (lead tetra-acetate, tripropopotassium boron hydride, etc.) or a hydrogen bond material and a site which undergoes a photochromic reaction in the same molecule. In JP-A No. 06-102616, an optical absorption layer which adjoins a recording layer containing a photochromic compound and comprising a pigment dispersion polymer membrane or a pigment vapor deposition film is provided so that when it is irradiated with a recording light, the optical absorption layer generates heat, the polymer binder of the recording layer softens and the reaction yield is improved.

However, these proposals presented problems of actual performance and construction, and have not been commercialized.

### SUMMARY OF THE INVENTION

It is therefore an object of the present invention to provide a photon mode optical memory device, and particularly an optical memory device using a photochromic compound as recording material, in where recorded information is not lost due to irradiation by read-out light.

The optical memory device of the present invention comprises a recording layer containing a photochromic compound and an electron-accepting compound, disposed above a substrate, and the electron-accepting compound is a Lewis acid compound containing an aliphatic group having carbon atoms of 12 or more. In another aspect, the optical memory device preferably contains an infrared agent in the recording layer or an exothermic layer.

The process for operating an optical memory device of the preset invention is suitably performed on the optical memory device of the preset invention.

One aspect of the process for operating an optical memory device of the present invention, comprises, a recording step of heating the recording layer temporarily to a melting point of the electron-accepting compound or higher, irradiating visible light including a wavelength corresponding to an absorption band of the colored photochromic compound, to an area including a recording part of the recording layer so as to decolorize, and then heating the area to a temperature lower than the melting point of the electron-accepting compound; and an erasing step of irradiating ultraviolet light to an area including the recording part so as to color the photochromic compound. The process may further comprise an initialization step of irradiating ultraviolet light to the optical memory device, so as to color the photochromic compound.

Another aspect of the operating an optical memory device of the present invention, comprises, a recording step of irradiating ultraviolet light to an area including a recording part of the recording layer so as to color the photochromic compound, and then heating the area to a temperature lower than a melting point of the electron-accepting compound; and an erasing step of heating the recording layer temporarily to the melting point of the electron-accepting compound or higher, irradiating visible light including a wavelength corresponding to an absorption band of the colored photochromic compound, to an area including the recording part, so as to decolorize, and then heating an area including the recording part to a temperature lower than the melting point of the electron-accepting compound. The process may further comprise an initialization step of heating the recording layer temporarily to the melting point of the electron-accepting compound or higher, and irradiating visible light including a wavelength corresponding to the absorption band of the colored photochromic compound, so as to decolorize the photochromic compound.

Another aspect of the process for operating an optical memory device of the present invention, comprises, a recording step of irradiating infrared light to the recording layer so as to heat the recording layer temporarily to a melting point of the electron-accepting compound, irradiating visible light including a wavelength corresponding to an absorption band of the colored photochromic compound, to an area including a recording part of the recording layer so as to decolorize, and then irradiating infrared light to the area so as to heat the area to a temperature lower than the melting point of the electron-accepting compound; and an erasing step of irradiating ultraviolet light to an area including the recording part so as to color the photochromic compound, and in which at least one of the recording layer and the exothermic layer contains an infrared absorption agent. The process may further comprise an initialization step of irradiating ultraviolet light to the optical memory device so as to color the photochromic compound.

Another aspect of the process for operating an optical memory device, comprises, a recording step of irradiating ultraviolet light to an area including a recording part of the recording layer so as to color the photochromic compound, and then irradiating infrared light to the area so as to heat the area to a temperature lower than a melting point of the electron-accepting compound; and an erasing step of irradiating infrared light to the recording layer so as to heat the recording layer temporarily to the melting point of the electron-accepting compound or higher, irradiating visible light including a wavelength corresponding to an absorption band of the colored photochromic compound, to an area including the recording part so as to decolorize, and then heating an area including the recording part to a temperature lower than the melting point of the electron-accepting compound, and in which at least one of the recording layer and the exothermic layer contains an infrared absorption agent. The process may further comprise an initialization step of irradiating infrared light to the recording layer so as to heat temporarily to the melting point of the electron-accepting compound or higher, and irradiating visible light including a wavelength corresponding to the absorption band of the colored photochromic compound, so as to decolorize the photochromic compound.

### BRIEF DESCRIPTION OF THE DRAWINGS

FIGS. 1A and 1B are schematic cross-sectional views showing the construction of an ordinary optical memory device.

FIG. 2 is a schematic diagram showing an example of the state of the acidic group of an electron-accepting compound, and the aromatic ring of a fulgide compound.

FIG. 3 is another schematic diagram showing an example of the state of the acidic group of an electron-accepting compound, and the aromatic ring of a fulgide compound.

FIG. 4 is a schematic cross-sectional view showing an example of the construction of the optical memory device of the present invention.

FIG. 5 is a schematic cross-sectional view showing another example of the construction of the optical memory device of the present invention.

FIG. 6 is a schematic cross-sectional view showing another example of the construction of the optical memory device of the present invention.

FIG. 7 is a schematic cross-sectional view showing another example of the construction of the optical memory device of the present invention.

FIG. 8 is a schematic cross-sectional view showing another example of the construction of the optical memory device of the present invention.

FIG. 9 is a schematic cross-sectional view showing another example of the construction of the optical memory device of the present invention.

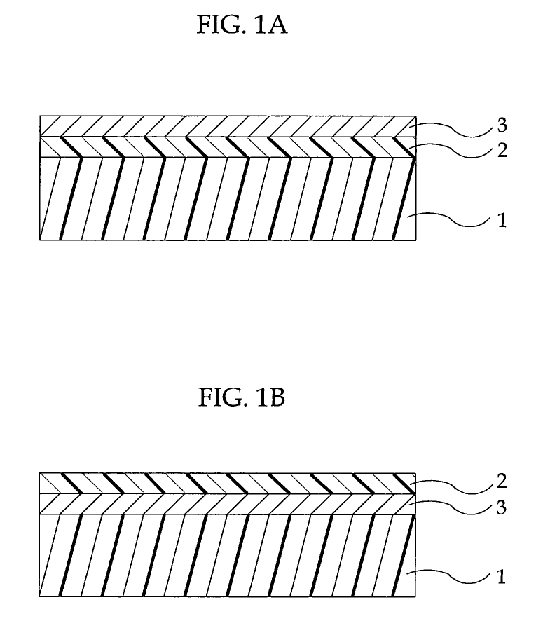

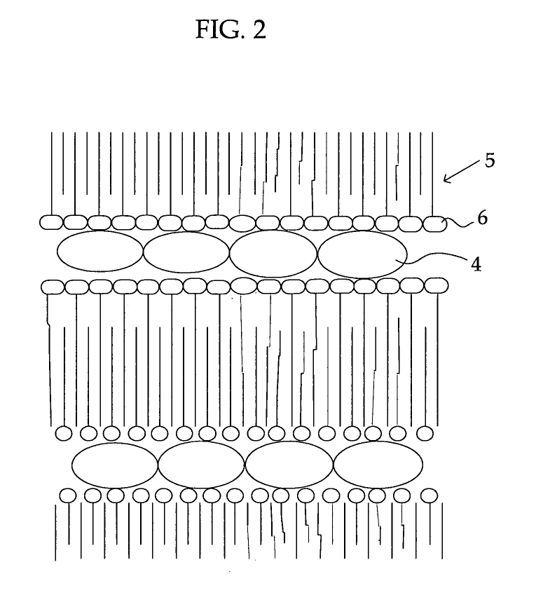

### DESCRIPTION OF THE PREFERRED EMBODIMENTS

[First Embodiment of Optical Device]

One of the features of the present invention is (1), an optical memory device comprising a recording layer containing at least a photochromic compound and an electron-accepting compound on a substrate, and if necessary further comprising a reflecting layer on this recording layer or between this recording layer and the substrate. This electron-accepting compound is a Lewis acid compound containing an aliphatic group having carbon atoms of 12 or more. The Lewis acid compound is preferably at least one of a phosphonic acid, an aliphatic carboxylic acid compound and a phenol compound.

Another feature of the present invention is (2), a process for operating an optical memory device by initialization, recording and erasure, comprising: a step of irradiating ultraviolet light to the whole surface of the optical memory device (1) so as to color the photochromic compound in the recording layer (an initialization step); a step of heating part of or the whole surface of the recording layer temporarily to the melting point of the electron-accepting compound or higher, irradiating visible light including the wavelength range corresponding to the absorption band of the colored photochromic compound, to a predetermined area (recording part) so as to decolorize the predetermined area (recording part), and thereafter heating an area including the aforesaid heated part (recording part) to a temperature lower than the melting point of the electron-accepting compound (a recording step); and a step of irradiating ultraviolet light to the predetermined area (recording part) so as to color the photochromic compound (an erasing step).

In this way, in a mode which permits reversible control of erasure sensitivity, wherein the whole surface is irradiated by ultraviolet light to put the recording layer in the colored state, and then irradiated by visible light to record information, it can temporarily be put in a state with a high decolorizing sensitivity to perform recording, and then changed over to a low sensitivity state for read-out so that the recording is not destroyed. This may be explained as follows.

The decolorizing sensitivity of a photochromic compound is directly dependent on a color erasing reaction quantum yield (φCE), and the ability to change of decolorizing sensitivity implies an ability to change φCE. Hereafter, change of φCE is described as a change of decolorizing sensitivity.

Taking the case of a fulgide compound as an example of the photochromic compound, in general, the decolorizing sensitivity of the fulgide compound is largely dependent on electron properties (electron donor/receptor properties) based on the following Formula 8, Formula 9 and chemical structure of the aromatic ring described later in the description of the above formulas.

Specifically, the decolorizing sensitivity tends to be smaller in structures where the electron donor property of the aromatic ring is larger, and the decolorizing sensitivity tends to be larger in structures where the electron donor property of the aromatic ring is smaller. Also, in compounds having a certain structure, the decolorizing sensitivity may also change with the electronic properties of the medium surrounding the molecule. In other words, the electronic properties of the aromatic ring appear to vary due to interaction with the medium. If the degree of interaction of electron receiving sites in the medium with the electron transfer of the aromatic ring of the fulgide compound becomes large, the electron donor property of this aromatic ring will decrease, and decolorizing sensitivity will increase. Conversely, if the degree of the interaction becomes small, the electron donor property of the aromatic ring will increase, and decolorizing sensitivity will decrease. Therefore, if the degree of this interaction is controlled, the decolorizing sensitivity can be controlled. This can be done by performing the process described in the process for operating optical memory device (2) on the recording layer containing the electron-accepting compound and photochromic compound having the structure disclosed in the optical memory device (1), which may be explained as follows.

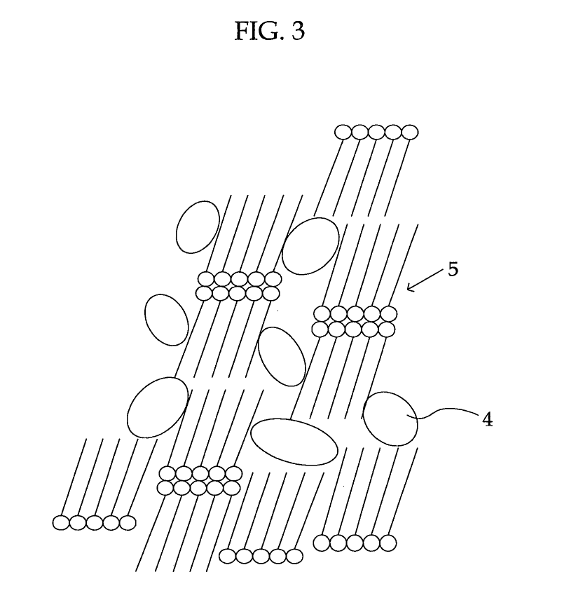

The fulgide compound in the recording layer of the optical memory device is colored by ultraviolet light irradiation. By subsequently heating the recording layer temporarily to a temperature (I), which is at the melting point of the electron-accepting compound or higher, a state where the electron-accepting compound is arranged somewhat regularly is formed. The acidic group of the electron-accepting compound is stabilized where it has a close interaction with the aromatic ring of the fulgide compound (hereafter, this state will be referred to as “State A”). A model diagram of this state is shown in FIG. 2, where “4” expresses the photochromic compound, “5” expresses the electron-accepting compound, and “6” expresses the acidic group of the electron-accepting compound. This is a state where the decolorizing sensitivity is large, and by irradiating with visible light in this state, recording can be performed in a short time using little energy. If the recording layer is then heated to a temperature (II) which lower than the melting point of the electron-accepting compound (it may also be temporarily heated to a temperature above the melting point of the electron-accepting compound, and then gradually cooled), the acidic groups of the electron-accepting compound cluster densely together, and are stabilized in a state with a low interaction with the aromatic rings of the fulgide compound (hereafter, this state will be referred to as “State B”). A model diagram of this state is shown in FIG. 3, where “4” expresses the photochromic compound, and “5” expresses the electron-accepting compound. This is a state where decolorizing sensitivity is low, therefore this is a state where color loss due to read-out light does not occur and where recording retention is high. This explains decolorizing sensitivity, but regarding coloration sensitivity, there is almost no change due to “State A” and “State B”.

In the step where temporary heating is performed to a temperature (I) which is at the melting point of the electron-accepting compound or higher, in order to obtain State A, when the melting point of the fulgide compound is higher than the melting point of the electron-accepting compound, it is preferred to heat to a higher temperature than the melting point of the fulgide compound, but there is no problem provided that it is higher than the melting point of the electron-accepting compound. After heating, quenching is preferred, as slow cooling increases the probability of changing to State B. This is because the heating temperature range for obtaining State B is in the low temperature range rather than the heating temperature range for obtaining State A. Therefore, State B can be obtained by heating the recording layer in State A to a specific temperature range. The setting of the temperatures used in the temporary heating to a temperature (I) which is at the melting point of the electron-accepting compound or higher, in order to obtain State A, and the heating to a temperature (II) which is lower than the melting point of the electron-accepting compound, in order to obtain State B, may be determined according to the kind and combination of the fulgide compound, electron-accepting compound and binder used.

Another feature of the present invention is (3), a process for operating an optical memory device, by initialization, recording and erasure, comprising: a step of heating the whole surface of the optical memory device (1) temporarily to the melting point of the electron-accepting compound or higher, and irradiating visible light including a wavelength range corresponding to an absorption band of the colored photochromic compound in the recording layer so as to decolorize the photochromic compound in the recording layer (an initialization step); a step of irradiating ultraviolet light to a predetermined area (recording part) so as to color the predetermined area (recording part), and heating the ultraviolet light-irradiated area to a temperature lower than the melting point of the electron-accepting compound (a recording step); and heating part of or the whole surface temporarily to the melting point of the electron-accepting compound or higher, irradiating visible light including a wavelength range corresponding to an absorption bond of the colored photochromic compound so as to decolorize it, and heating an area including at least the above heated area to a temperature lower than the melting point of the electron-accepting compound (an erasing step).

In this process, wherein reversible control of decolorizing sensitivity can be performed, the whole surface is irradiated with visible light to decolorize the recording layer, and is then irradiated with ultraviolet light to record information. After recording, an area including the recording part is changed over to a low sensitivity state, so the recording is not destroyed by visible light irradiation during read-out. For erasure, it is temporarily changed over to a high decolorizing sensitivity, and is then irradiated by visible light to erase the information.

The relation between the interaction of the photochromic compound with the electron-accepting compound and decolorizing sensitivity, and heat treatment to change over the aforesaid interaction, are described in an identical way to that of the process for operating an optical memory device (2).

[Second Embodiment of Optical Device]

Another improved feature of the present invention is (4), an optical memory device comprising a recording layer containing a photochromic compound and an electron-accepting compound on a substrate, and if necessary a reflecting layer. This recording layer further comprises an infrared absorption agent, and the electron-accepting compound is a Lewis acid compound containing an aliphatic group having carbon atoms of 12 or more.

Another feature of the present invention is (5), an optical memory device comprising a recording layer containing a photochromic compound and an electron-accepting compound, and an exothermic layer containing an infrared absorption agent, on a substrate, and if necessary a reflecting layer. The electron-accepting compound is a Lewis acid compound containing an aliphatic group having carbon atom of 12 or more.

Another feature of the present invention is (6), a process for operating an optical memory device (image processing process) by initialization, recording and erasure, comprising: a step of irradiating ultraviolet light to the whole surface of the optical memory device (4) or (5) so as to color the photochromic compound in the recording layer (an initialization step); a step of irradiating infrared light to part of or the whole surface of the recording layer so as to temporarily heat the infrared light-irradiated area to the melting point of the electron-accepting compound or higher, irradiating visible light including a wavelength range corresponding to an absorption band of the colored photochromic compound to a predetermined area (recording part) so as to decolorize the visible light-irradiated area, and thereafter, irradiating infrared light to an area including the aforesaid heated area so as to heat the area to a temperature lower than the melting point of the electron-accepting compound (a recording step); and a step of irradiating ultraviolet light to the predetermined area (recording part) so as to color the photochromic compound (an erasing step).

Another feature of the present invention is (7), a process for operating an optical memory device (image processing process) by initialization, recording and erasure, comprising: a step of irradiating infrared light to the whole surface of the optical memory device (4) or (5) so as to temporarily heat it to the melting point of the electron-accepting compound or higher, irradiating visible light which includes a wavelength range corresponding to an absorption band of the colored photochromic compound in the recording layer, to the whole surface so as to decolorize the photochromic compound in the recording layer (an initialization step); a step of irradiating ultraviolet light to a predetermined area (recording part) so as to color the photochromic compound, and thereafter irradiating infrared light to an area including the ultraviolet light-irradiated area so as to heat the area to a temperature lower than the melting point of the electron-accepting compound (a recording step); and a step of irradiating infrared light to part of or the whole surface of the recording layer so as to temporarily heat part of or the whole surface of the recording layer to the melting point of the electron-accepting compound or higher, irradiating visible light including a wavelength range corresponding to an absorption band of the colored photochromic compound so as to decolorize the photochromic compound, and thereafter, irradiating infrared light to an area including the aforesaid heated area so as to heat the area to a temperature lower than the melting point of the electron-accepting compound (an erasing step).

The step for temporarily heating to the temperature (I), which is at the melting point of the electron-accepting compound or higher, to obtain State A, and the step for heating to the temperature (II), which is lower than the melting point of the electron-accepting compound, to obtain State B, are possible due to the infrared absorption agent contained in the recording layer of the optical memory device (4) or the infrared absorption agent contained in the exothermic layer of the optical memory device (5) which generate heat by irradiation of infrared light.

The infrared absorption agent may be an infrared absorption colorant, particularly suitable examples being colorants such as naphthalocyanine dyes, cyanine dyes, metal complex pigments, and the like, which absorb in the infrared region at 700 nm or higher.

The light source used for irradiating infrared light may be a combination of an infrared lamp and optical filters to cut out unnecessary wavelengths, and light-emitting elements which emit light of specific wavelengths such as LED and LD may also be used. If the whole surface of the optical memory is to be irradiated, a light source of large irradiation size, an array of optical devices or a suitable optical system adjusted to a predetermined irradiation size, may be used. If small, specific areas of the optical memory device are to be irradiated, a suitable optical system adjusted to a predetermined irradiation size may likewise be used.

The heating temperature of the recording layer can be controlled by adjusting the irradiation intensity and irradiation time of the infrared light.

The fulgide compounds which can be used in the present invention may be the fulgide compound shown by following Formula 8, the fulgide compound shown by following Formula 9 or compounds exhibiting a photochromic property having these compounds in their structure.

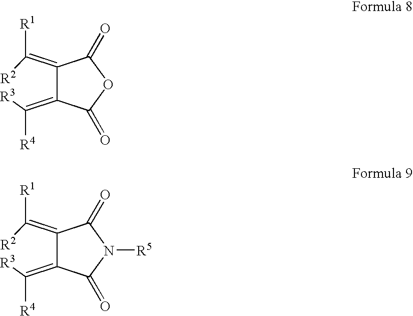

(in Formulas 8 and 9, each of R¹, R², R³, R⁴, and R⁵ expresses one of a hydrogen atom, an alkyl group, an alkoxy group, an aromatic ring, a heterocyclic ring, and the like, and at least one of R¹, R², R³, and R⁴ is a structure containing an aromatic or heterocyclic ring).

Specific examples of the fulgide compound include 2-[1-(1, 2-dimethyl-5-dimethylamino-3-indolyl) ethylidene]-3-isopropylidene succinic acid anhydride, and the like.

Another feature of the present invention is (8), a fulgide compound used as the photochromic compound which is a component of the recording layer.

As is known in the art, fulgide compounds are “thermally irreversible” photochromic materials with a coloring state which is stable to heat, and are a suitable component of the recording layer of the optical memory device according to the present invention.

In the aforesaid fulgide compound, the erasing reaction quantum yield (φCE) which is a determining factor mentioned above concerning decolorizing sensitivity varies greatly with electronic properties (electron donor/acceptor properties) based on the chemical structure of the aromatic ring. The decolorizing sensitivity is smaller, the larger the electron donor property of the aromatic ring is, and the decolorizing sensitivity is larger, the smaller the electron donor property is. Further, in compounds having this specific structure, the electronic properties of the aromatic ring show an apparent change due to interactions arising from the electronic properties of the medium surrounding the molecule. If there is a large interaction between electron receiving sites in the medium and the aromatic ring in the fulgide compound, electron donor properties of the aromatic ring decrease and color erasure sensitivity increases. Conversely, if there is only a small interaction, electron donor properties of the aromatic ring increase and color erasure sensitivity decreases. Therefore, the color erasure sensitivity can be controlled by controlling the degree of interaction.

The diarylethene compounds which can be used in the present invention may be the diarylethene compound shown by following Formula 10, or compounds exhibiting a photochromic property having this compound in their structure.

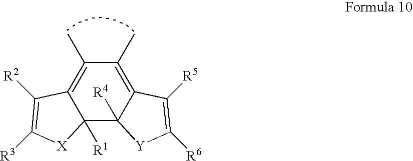

(in Formula 10, each of R¹, R², R³, R⁴, R⁵ and R⁶ expresses one of a hydrogen atom, an alkyl group, an alkoxy group, an aromatic ring, a heterocyclic ring, and the like, and each of X and Y expresses one of an oxygen atom, a sulfur atom and a nitrogen atom, and when X or Y is a nitrogen atom, at least one of an alkyl group, an alkoxy group, an aromatic ring, a hetrocyclic ring, and the like may further bonded thereto.)

Another feature of the present invention is (9), a diarylethene compound used as the photochromic compound which is a component of the recording layer.

As is known in the art, diarylethene compounds are “thermally irreversible” photochromic materials with a coloring state which is stable to heat, and like fulgides, are a suitable component of the recording layer of the optical memory device according to the present invention. Specific example of the diarylethene includes, 1,2-bis-(2-methyl-5-(4-dimethylamino) phenyl-3-thienyl)-3,3,4,4,5,5-hexafluorocyclopentene, and the like. For example, in the case of a diarylethene compound, the erasing reaction quantum yield (φCE) is closely related to the electronic properties (electron donor/acceptor) based on the chemical structure of specific sites, such as two five-membered rings and sites including R², R³ and R⁵, R⁶ in Formula 10. The decolorizing sensitivity is smaller, the larger the electron donor property of the above-mentioned specific sites is, and the decolorizing sensitivity is larger, the smaller the electron donor property is. Further, in the diarylethene compound having a specific structure, the electronic properties of the above-mentioned specific sites show an apparent change due to interactions arising from the electronic properties of the medium surrounding the molecule. If there is a large interaction between electron receiving sites in the medium and the specific sites in the diarylethene compound, electron donor properties of the specific sites decrease and color erasure sensitivity increases. Conversely, if there is only a small interaction, electron donor properties of the specific sites increase and color erasure sensitivity decreases. Therefore, the color erasure sensitivity can be controlled by controlling the degree of interaction.

The electron-accepting compound of the present invention is a Lewis acid compound basically having, within its molecule, a structural part which interacts with the aromatic ring of the fulgide compound to change the electronic properties of the aromatic ring, and a long chain structure part including an aliphatic chain structure or the like, which controls intermolecular cohesion forces. More preferably, the electron-accepting compound is a phosphonic acid compound, aliphatic carboxylic acid compound, or phenol compound having a Lewis acid part and a long chain structure part having carbon atoms of 12 or more. It is particularly preferred that the long chain structure part has carbon atoms of 12 to 100. The long chain structure part includes straight chain or branched alkyl groups and straight chain or branched alkenyl groups, and may also have substituent groups such as halogen, alkoxy, ester and the like.

The phosphone acid compound (10) is a compound expressed by following Formula 1:

R¹—PO(OH)₂ Formula 1

(where, R¹ expresses a long chain structure having carbon atoms of 12 or more, including an aliphatic group or the like).

The organophosphorus acid compound expressed by Formula 1 may for example be the following: dodecylphosphonic acid, tetradecylphosphonic acid, hexadecylphosphonic acid, octadecylphosphonic acid, eicosylphosphonic acid, docosylphosphonic acid, tetracosylphosphonic acid, hexacosylphosphonic acid, octacosylphosphonic acid, and the like.

The aliphatic carboxylic acid compound (11), is an α-hydroxyaliphatic carboxylic acid compound expressed by following Formula 2:

R²—CH(OH)—COOH Formula 2

(where, R² expresses a long chain structure having carbon atoms of 12 or more, including an aliphatic group or the like).

The α-hydroxyaliphatic carboxylic acid compound expressed by Formula 2 may for example be the following: α-hydroxydodecanoic acid, α-hydroxytetradecanoic acid, α-hydroxyhexadecanoic acid, α-hydroxyoctadecanoic acid, α-hydroxypentadecanoic acid, α-hydroxyeicosanoic acid, α-hydroxydocosanoic acid, α-hydroxytetracosanoic acid, α-hydroxyhexacosanoic acid, α-hydroxyoctacosanoic acid, and the like.

The aliphatic carboxylic acid compound (12), is an aliphatic carboxylic acid compound, which has a long chain structure having carbon atoms of 12 or more, including an aliphatic group substituted by halogen atoms or the like, and at least one of the carbon atom at α position and the carbon atom at β position is bonded to the halogen atom. Specific examples of this acid compound are the following: 2-bromohexadecanoic acid, 2-bromoheptadecanoic acid, 2-bromooctadecanoic acid, 2-bromoeicosanoic acid, 2-bromodocosanoic acid, 2-bromotetracosanoic acid, 3-bromooctadecanoic acid, 3-bromoeicosanoic acid, 2,3-dibromooctadecanoic acid, 2-fluorododecanoic acid, 2-fluorotetradecanoic acid, 2-fluorohexadecanoic acid, 2-fluorooctadecanoic acid, 2-fluoroeicosanoic acid, 2-fluorodocosanoic acid, 2-iodohexadecanoic acid, 2-iodooctadecanoic acid, 3-iodohexadecanoic acid, 3-iodooctadecanoic acid, perfluorooctadecanoic acid, and the like.

The aliphatic carboxylic acid compound (13), is an aliphatic carboxylic acid compound, which has a long chain structure having carbon atoms of 12 or more, including an aliphatic group having an oxo group in its carbon chain or the like, and at least one of the carbon atom at α position, the carbon atom at β position, and the carbon atom at γ position is the oxo group. Specific examples of this acid compound are the following: 2-oxododecanoic acid, 2-oxotetradecanoic acid, 2-oxohexadecanoic acid, 2-oxooctadecanoic acid, 2-oxoeicosanoic acid, 2-oxotetracosanoic acid, 3-oxododecanoic acid, 3-oxotetradecanoic acid, 3-oxohexadecanoic acid, 3-oxooctadecanoic acid, 3-oxoeicosanoic acid, 3-oxotetracosanoic acid, 4-oxohexadecanoic acid, 4-oxooctadecanoic acid, 4-oxodocosanoic acid, and the like.

The aliphatic carboxylic acid compound (14), is a dibasic acid expressed by Formula 3:

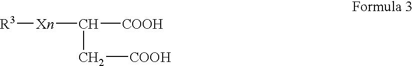

(where, R³ expresses a long chain structure having carbon atoms of 12 or more, including an aliphatic group or the like, X expresses an oxygen atom or a sulfur atom, when X is an oxygen atom, n is 1, and when X is a sulfur atom, n is 1 or 2).

A specific example of the dibasic acid expressed by Formula 3 is the following: 2-(dodecyloxy)succinic acid, 2-(tetradecyloxy)succinic acid, 2-(hexadecyloxy)succinic acid, 2-(octadecyloxy)succinic acid, 2-(eicosyloxy)succinic acid, 2-(docosyloxy)succinic acid, 2-(tetracosyloxy)succinic acid, 2-(dodecylthio)succinic acid, 2-(tetradecylthio)succinic acid, 2-(hexadecylthio)succinic acid, 2-(octadecylthio)succinic acid, 2-(eicosylthio)succinic acid, 2-(docosylthio)succinic acid, 2-(tetracosylthio)succinic acid, 2-(dodecyldithio)succinic acid, 2-(tetradecyldithio)succinic acid, 2-(hexadecyldithio)succinic acid, 2-(octadecyldithio)succinic acid, 2-(eicosyldithio)succinic acid, 2-(docosyldithio)succinic acid, 2-(tetracosyldithio)succinic acid, and the like.

The aliphatic carboxylic acid compound (15), is a dibasic acid expressed by Formula 4:

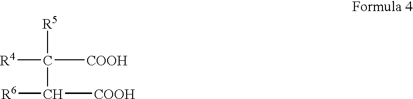

(where, R⁴, R⁵, and R⁶ express a hydrogen atom or an aliphatic group, and at least one thereof is a long chain structure having carbon atoms of 12 or more, including an aliphatic group or the like).

A specific example of the dibasic acid expressed by Formula 4 is the following: dodecylsuccinic acid, tridecylsuccinic acid, tetradecylsuccinic acid, pentadecylsuccinic acid, octadecylsuccinic acid, eicosylsuccinic acid, docosylsuccinic acid, 2,3-dihexadecylsuccinic acid, 2,3-dioctadecylsuccinic acid, 2-methyl-3-dodecylsuccinic acid, 2-methyl-3-tetradecylsuccinic acid, 2-methyl-3-hexadecylsuccinic acid, 2-ethyl-3-dodecylsuccinic acid, 2-propyl-3-dodecylsuccinic acid, 2-octyl-3-hexadecylsuccinic acid, 2-tetradecyl-3-octadecylsuccinic acid, and the like.

The aliphatic carboxylic acid compound (16), is a dibasic acid expressed by Formula 5:

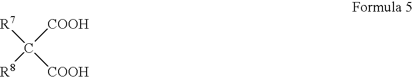

(where, R⁷ and R⁸ express a hydrogen atom or an aliphatic group, and at least one thereof is a long chain structure having carbon atoms of 12 or more, including an aliphatic group or the like).

A specific example of the dibasic acid expressed by Formula 5 is the following: dodecylmalonic acid, tetradecylmalonic acid, hexadecylmalonic acid, octadecylmalonic acid, eicosylmalonic acid, docosylmalonic acid, tetracosylmalonic acid, didodecylmalonic acid, ditetradecylmalonic acid, dihexadecylmalonic acid, dioctadecylmalonic acid, dieicosylmalonic acid, didocosylmalonic acid, methyloctadecylmalonic acid, methyleicosylmalonic acid, methyldocosylmalonic acid, methyltetracosylmalonic acid, ethyloctadecylmalonic acid, ethyleicosylmalonic acid, ethyldocosylmalonic acid, ethyltetracosylmalonic acid, and the like.

The aliphatic carboxylic acid compound (17), is the dibasic acid expressed by Formula 6:

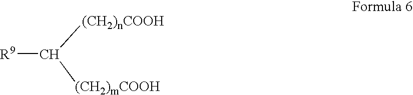

(where, R⁹ express a long chain structure having carbon atoms of 12 or more, including an aliphatic group or the like, n expresses 0 or 1, m expresses 1, 2 or 3, when n is 0, m is 2 or 3, and when n is 1, m is 1 or 2).

A specific example of the dibasic acid expressed by Formula 6 is the following: 2-dodecylglutaric acid, 2-hexadecylglutaric acid, 2-octadecylglutaric acid, 2-eicosylglutaric acid, 2-docosylglutaric acid, 2-dodecyladipic acid, 2-pentadecyladipic acid, 2-octadecyladipic acid, 2-eicosyladipic acid, 2-docosyladipic acid, and the like.

The phenol compound (18), is a compound expressed by Formula 7:

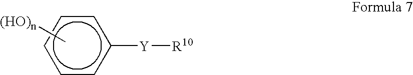

(where, Y expresses —S—, —O—, —CONH— or —COO—, R¹⁰ expresses a long chain structure having carbon atoms of 12 or more, including an aliphatic group or the like, and n expresses the integer 1, 2 or 3).

The phenol compound expressed by Formula 7 may for example be the following: p-(dodecylthio)phenol, p-(tetradecylthio)phenol, p-(hexadecylthio)phenol, p-(octadecylthio)phenol, p-(eicosylthio)phenol, p-(docosylthio)phenol, p-(tetracosylthio)phenol, p-(dodecyloxy)phenol, p-(tetradecyloxy)phenol, p-(hexadecyloxy)phenol, p-(octadecyloxy)phenol, p-(eicosyloxy)phenol, p-(docosyloxy)phenol, p-(tetracosyloxy)phenol, p-dodecylcarbamoylphenol, p-tetradecylcarbamoylphenol, p-hexadecylcarbamoylphenol, p-octadecylcarbamoylphenol, p-eicosylcarbamoylphenol, p-docosylcarbamoylphenol, p-tetracosylcarbamoylphenol, hexadecyl gallate, octadecyl gallate, eicosyl gallate, docosyl gallate, tetracosyl gallate, and the like.

A binder material may if necessary be used as a component of the recording layer of the optical memory device (1) in addition to the photochromic compound, that is, the fulgide compound or the diarylethene compound and the electron-accepting compound, without any adverse effect on the photochromism function of the photochromic compound. Here, it is preferred to use a resin material which is compatible with the photochromic compound and the electron-accepting compound, can form a film, and has excellent post-cure transparency.

A binder material may if necessary also be used as a component of the recording layer of the optical memory device (4) or (5) in addition to the photochromic compound, that is, the fulgide compound or the diarylethene compound, the electron-accepting compound and the infrared absorption agent, without any adverse effect on the photochromism function of the photochromic compound. Here, it is preferred to use a resin material which is compatible with the photochromic compound, the electron-accepting compound and the infrared absorption agent, can form a film, and has excellent post-cure transparency. Such materials include, for example, polystyrenes, polyesters, polyamide, polycarbonates, poly(methyl methacrylate), copoly(vinyl chloride-vinylidene chloride), poly(vinyl chloride), poly(vinylidene chloride), poly(vinyl acetate), and the like. Phenoxy resins, aromatic polyesters, phenolic resins, and epoxy resins can also be used.

The material of the substrate may be a transparent material such as polyethylene terephthalate, polyethersulfone, polycarbonate or the like.

The mixing ratio of the photochromic compound, electron-accepting compound and binder material which are the component elements of the recording layer may vary according to the combination of materials used and cannot be uniquely defined, but good results are generally obtained when they are mixed in the ranges photochromic compound: 5% by weight to 30% by weight, electron-accepting compound: 20% by weight to 80% by weight and binder material: 20% by weight 50% by weight.

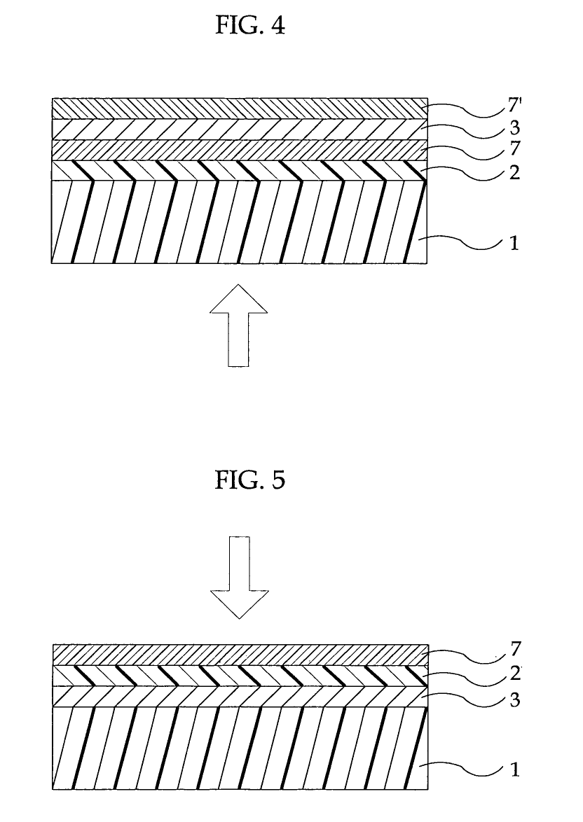

A reflecting layer is provided on the recording layer which is on the substrate, as a component of the optical memory device. In this case, a protection layer “7 or 7′” if desired may be provided between the recording layer “2” and the reflecting layer “3”, or on the reflecting layer “3” (FIG. 4), or the reflecting layer “3”, the recording layer “2” and the protection layer “7” may be provided on the substrate “1” in this order (FIG. 5).

In the case of the optical memory device shown in FIG. 4, it is suitable to irradiate the irradiation light from the substrate side as shown with the arrow, and in the case of the optical memory device shown in FIG. 5, it is suitable, conversely, to irradiate the irradiation light from above the layer provided on the substrate as shown with the arrow.

In the optical memory device (4) or (5), a binder material may likewise be used if necessary as a component material of the recording layer. The material forming the exothermic layer may be the aforesaid infrared absorption agent, and if necessary, a binder material may also be used. Such materials include, for example, polystyrenes, polyesters, polycarbonates, poly(methyl methacrylate), copoly(vinyl chloride-vinylidene chloride), poly(vinyl chloride), poly(vinylidene chloride), poly(vinyl acetate), and the like. Phenoxy resins, aromatic polyesters, phenolic resins, and epoxy resins can also be used.

The mixing ratio of the photochromic compound, electron-accepting compound and binder material which are the component elements of the recording layer may vary according to the combination of materials used and cannot be uniquely defined, but good results are obtained when they are mixed in the ranges photochromic compound: 5% by weight to 30% by weight, electron-accepting compound: 20% by weight to 80% by weight and binder material: 20% by weight to 50% by weight.

The mixing ratio of the infrared absorption agent and binder material which are the component elements of the exothermic layer may also vary according to the combination of materials used and cannot be uniquely defined, but good results are generally obtained when they are mixed in the ranges infrared absorption agent: 20% by weight to 80% by weight, binder material: 20% by weight to 80% by weight.

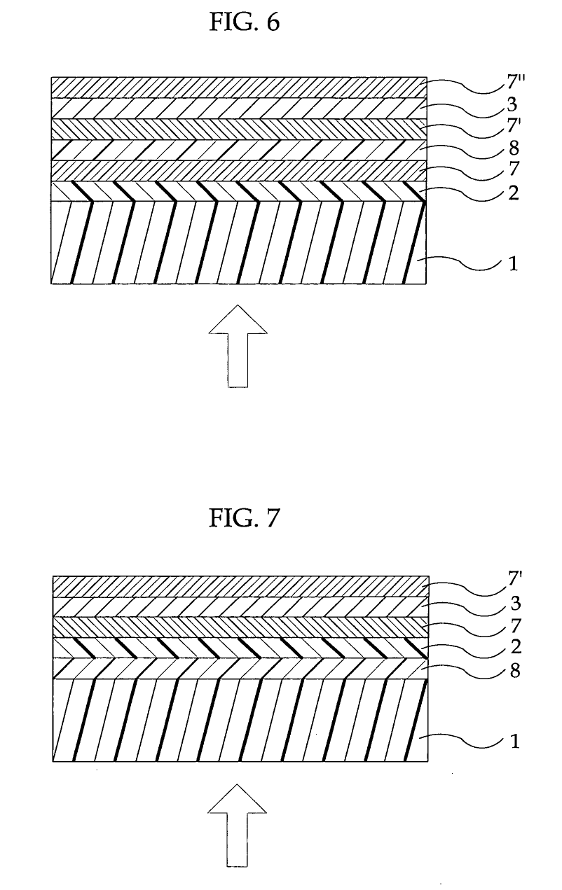

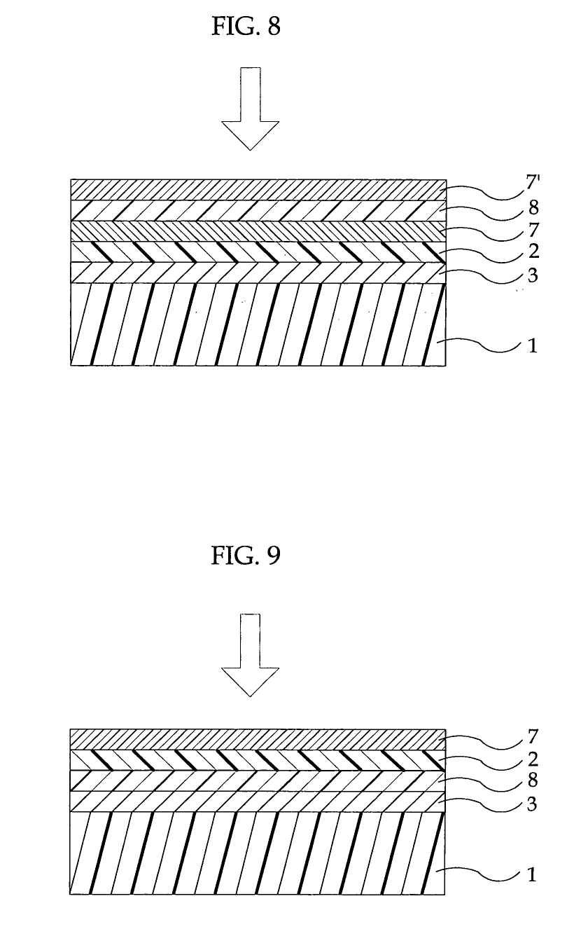

The optical memory devices (4) and (5) may be formed by providing the recording layer “2”, the exothermic layer “8” and the reflecting layer “3” in this order on the substrate “1”, and a protection layer “7, 7′, or 7″” if desired for example between the recording layer “2” and the exothermic layer “8”, between the exothermic layer “8” and the reflecting layer “3” or on the reflecting layer “3” (FIG. 6), by providing the exothermic layer “8”, the recording layer “2” and the reflecting layer “3” in this order on the substrate “1”, and a protection layer “7 or 7′” if desired for example between the recording layer “2” and reflecting layer “3” or on the reflecting layer “3” (FIG. 7), by providing the reflecting layer “3”, the recording layer “2” and the exothermic layer “8” in this order on the substrate “1”, and a protection layer “7 or 7′” if desired for example between the recording layer “2” and the exothermic layer “8” or on the exothermic layer “8” (FIG. 8), or by providing the reflecting layer “3”, the exothermic layer “8” and the recording layer “2” in this order on the substrate “1”, and a protection layer “7” if desired for example on the recording layer “2” (FIG. 9).

In the case of the optical memory devices shown in FIG. 6 and FIG. 7, it is suitable to irradiate the irradiation light from the substrate side as shown with the arrow, and in the case of the optical memory devices shown in FIG. 8 and FIG. 9, it is suitable, conversely, to irradiate the irradiation light from above the layer provided on the substrate as shown with the arrow.

As a method of forming the recording layer and the exothermic layer, in addition to a coating method such as the printing method, spin coat method and blade method, a vapor deposition method can be used. The thickness of the recording layer and the exothermic layer is preferably of the order of 0.5 μm to 10 μm.

The light source which emits ultraviolet light may be a mercury lamp, xenon lamp, or the like combined with an optical filter to extract ultraviolet light in the desired wavelength band, or a light-emitting element which emits light in a specific wavelength band such as an LED or LD. It may also be suitably selected depending on whether the whole surface or a predetermined area (recording part) of the element is to be irradiated.

The light source which emits visible light may be a lamp comprising a white light source combined with an optical filter, or a light-emitting element which emits light in a specific wavelength band such as an LED or LD. It may also be suitably selected depending on whether the whole surface or a predetermined area (recording part) of the element is to be irradiated.

Regarding the method of temporarily heating the recording layer to the melting point or higher, or a temperature lower than the melting point of the electron-accepting compound, when only a predetermined area (recording part) is to be heated, a light-emitting element such as an LED or LD which emits visible light or infrared light in the long wavelength region can be used, and when the whole surface is to be heated, a heater such as a heat roller, thermal head, halogen heater, ceramic heater, quartz tube heater, or the like can be used in addition to the aforesaid light-emitting element.

Another feature of the present invention (19), is the provision of the protection layer on the surface of the recording layer (FIG. 4, FIG. 5, FIG. 6, FIG. 7, FIG. 8, and FIG. 9), on the surface of the reflecting layer (FIG. 5, FIG. 6, and FIG. 7) or on the surface of the exothermic layer (FIG. 8). The material of the protection layer may suitably be a silicone resin, an alkyl resin or PVA (polyvinyl alcohol) which have a high transparency and hardness. If it is provided on the surface of the reflecting layer, there is no need for high transparency. The protection layer can reduce the adverse effect of water or specific gases on reactions relating to functions required of the compounds in the recording layer, and as it gives effective protection against mechanical damage, it also improves durability. The thickness of the reflecting layer is preferably 50 nm to 300 nm (500 Å to 3,000 Å).

Hereafter, the present invention will be described in detail by means of specific examples.

[Example of the embodiment of the optical memory device (1)]

### EXAMPLE 1

Using 2-[1-(1,2-dimethyl-5-dimethylamino-3-indolyl)ethylidene]-3-isoprop ylidene succinic acid anhydride (hereafter, referred to as PC1) as the photochromic compound, docosyl phosphonic acid as the electron-accepting compound and polystyrene as the binder, an optical memory device was manufactured by preparing a coating solution by adding 10 parts by weight of docosyl phosphonic acid (melting point 98° C.) and 9 parts by weight of polystyrene to 1 part by weight of PC1 using dihydropyrane as a solvent, casting on a PES (polyethersulfone) substrate to form a recording layer (2 nm), and forming a PVA protection layer (2 nm) and an aluminum reflecting layer (0.15 nm).

<Initialization Step>

When the whole recording layer surface was irradiated by ultraviolet light from the substrate side, the PC1 in the irradiated part colored to give a cyan coloration.

<Recording Step>

Next, the whole surface of the recording layer was heat-treated by a heat roller from the reflecting layer side until it temporarily reached 110° C., and the recording layer turned blue. When part of the recording layer in this state was irradiated by a semiconductor laser having a light emission wavelength of 650 nm, the PC1 in the irradiated part decolorized and became almost colorless. Next, when the whole surface of the recording layer was heat-treated by the heat roller until it temporarily reached 80° C., the semiconductor laser irradiation part turned pale yellow, and the other parts were cyan color.

<Reproduction Step>

When both parts were respectively irradiated by the semiconductor laser, a remarkable difference was observed between the two parts in the intensity of reflected light. Both parts were then irradiated for a long time by the laser light, but no change at all was seen in either part.

<Erasing Step>

Next, both parts were irradiated with ultraviolet light, and as the part with the pale yellow color changed to cyan, the whole became a uniform cyan color.

After the aforesaid recording, reproduction and erasure steps were performed 1,000 times, the optical behavior of the recording layer in each step was substantially same as the beginning, and the steps could be performed repeatedly any number of times.

### EXAMPLE 2

An optical memory device was manufactured as in Example 1.

<Initialization Step>

When the whole surface of the recording layer was heat-treated by a heat roller from the reflecting layer side until it temporarily reached 110° C., and the whole surface was irradiated from the substrate side using a red lamp light source, the PC1 decolorized and became almost colorless.

<Recording Step>

Next, when part of the recording layer in this state was irradiated with ultraviolet light, the PC1 in the irradiated part turned blue. When the whole surface was then heat-treated by a heat roller until the recording layer in the area including the irradiated part temporarily reached 80° C., the irradiated part turned to cyan color and the other parts changed to a pale yellow color.

<Reproduction Step>

When both parts were respectively irradiated by the semiconductor laser, a remarkable difference was observed between the two parts in the intensity of reflected light. Both parts were then irradiated for a long time by the laser light, but no change at all was seen in either part.

<Erasing Step>

When the whole surface of the recording layer was heat-treated by the heat roller from the reflecting layer side until it temporarily reached 110° C., the part which was cyan color changed to blue, and the part which was pale yellow became almost colorless. Next, when both parts were irradiated by a semiconductor laser having a light emission wavelength of 650 nm, the part which was almost colorless showed no change. As the part which was blue became almost colorless, both parts assumed the same state. When the whole surface of the recording layer was then heat-treated by the heat roller from the reflecting layer side until it temporarily reached 80° C., the almost colorless part turned pale yellow.

After the aforesaid recording, reproduction and erasure steps were performed 1,000 times, the optical behavior of the recording layer in each step was substantially same as the beginning, and the steps could be performed repeatedly any number of times.

### EXAMPLE 3

An optical memory device was manufactured as in Example 1, except that 1,2-bis-(2-methyl-5-(4-dimethylamino) phenyl-3-thienyl)-3,3,4,4,5,5-hexafluorocyclopentene (hereafter, referred to as PC2) was used as the photochromic compound.

<Initialization Step>

When the whole recording layer surface was irradiated by ultraviolet light from the substrate side, the PC2 in the irradiated part colored to give a blue coloration.

<Recording Step>

Next, the whole surface of the recording layer was heat-treated by a heat roller from the reflecting layer side until it temporarily reached 110° C., and the recording layer turned violet. When part of the recording layer in this state was irradiated by a semiconductor laser having a light emission wavelength of 650 nm, the PC2 in the irradiated part decolorized and became almost colorless. Next, when the whole surface of the recording layer was heat-treated by the heat roller until it temporarily reached 80° C., the semiconductor laser irradiation part remained colorless, but the other parts were blue.

<Reproduction Step>

When both parts were respectively irradiated by the semiconductor laser, a remarkable difference was observed between the two parts in the intensity of reflected light. Both parts were then irradiated for a long time by the laser light, but no change at all was seen in either part.

<Erasing Step>

Next, when both parts were irradiated with ultraviolet light, as the colorless parts turned to blue, the whole became a uniform blue color.

After the aforesaid recording, reproduction and erasure steps were performed 1,000 times, the optical behavior of the recording layer in each step was substantially same as the beginning, and the steps could be performed repeatedly any number of times.

### COMPARATIVE EXAMPLE 1

An optical memory device was manufactured in an effectively identical way to that of Example 1. However, the docosyl phosphonic acid which is the electron-accepting compound was omitted from the component elements of the recording layer, and 19 parts by weight of polystyrene were used relative to 1 part by weight of PC1.

<Initialization Step>

When the whole recording layer surface was irradiated by ultraviolet light from the substrate side, the PC1 in the irradiated part colored to give a cyan coloration.

<Recording Step>

Next, the whole surface of the recording layer was heat-treated by a heat roller from the reflecting layer side until it temporarily reached 110° C., but showed no change. Part of the recording layer in this state was irradiated by a semiconductor laser having a light emission wavelength of 650 nm, but the PC1 in the irradiated part was hardly decolorized and no change was observed, so the recording step could not be performed.

### EXAMPLE 4

An optical memory device was manufactured exactly as in Example 1, except that α-hydroxytetradecanoic acid was used as the electron-accepting compound. The initialization step, recording step, reproduction step and erasing step were performed as in Example 1.

After the aforesaid recording, reproduction and erasure steps were performed 1000 times, the optical behavior of the recording layer in each step was substantially same as the beginning, and the steps could be performed repeatedly any number of times. In Example 4, decolorizing of the PC1 in the semiconductor laser irradiation part in the recording step took slightly more time than in the case of Example 1.

### EXAMPLE 5

An optical memory device was manufactured exactly as in Example 1, except that 2-fluoro-octadecanoic acid was used as the electron-accepting compound. The initialization step, recording step, reproduction step and erasing step were performed as in Example 1.

After the aforesaid recording, reproduction and erasure steps were performed 1,000 times, the optical behavior of the recording layer in each step was substantially same as the beginning, and the steps could be performed repeatedly any number of times. In Example 5, decolorizing of the PC1 in the semiconductor laser irradiation part in the recording step took almost twice as long as in the case of Example 1.

### EXAMPLE 6

An optical memory device was manufactured exactly as in Example 1, except that 2-oxo-octadecanoic acid was used as the electron-accepting compound. The initialization step, recording step, reproduction step and erasing step were performed as in Example 1.

After the aforesaid recording, reproduction and erasure steps were performed 1,000 times, the optical behavior of the recording layer in each step was substantially same as the beginning, and the steps could be performed repeatedly any number of times. In Example 6, decolorizing of the PC1 in the semiconductor laser irradiation part in the recording step took almost twice as long as in the case of Example 1.

### EXAMPLE 7

An optical memory device was manufactured exactly as in Example 1, except that 2-(octadecylthio)succinic acid was used as the electron-accepting compound. The initialization step, recording step, reproduction step and erasing step were performed as in Example 1.

After the aforesaid recording, reproduction and erasure steps were performed 1,000 times, the optical behavior of the recording layer in each step was substantially same as the beginning, and the steps could be performed repeatedly any number of times.

### EXAMPLE 8

An optical memory device was manufactured exactly as in Example 1, except that octadecylsuccinic acid was used as the electron-accepting compound. The initialization step, recording step, reproduction step and erasing step were performed as in Example 1.

After the aforesaid recording, reproduction and erasure steps were performed 1,000 times, the optical behavior of the recording layer in each step was substantially same as the beginning, and the steps could be performed repeatedly any number of times. In Example 8, decolorizing of the PC1 in the semiconductor laser irradiation part in the recording step took slightly more time than in the case of Example 1.

### Example 9

An optical memory device was manufactured exactly as in Example 1, except that octadecylmalonic acid was used as the electron-accepting compound. The initialization step, recording step, reproduction step and erasing step were performed as in Example 1.

After the aforesaid recording, reproduction and erasure steps were performed 1,000 times, the optical behavior of the recording layer in each step was substantially same as the beginning, and the steps could be performed repeatedly any number of times.

### Example 10

An optical memory device was manufactured exactly as in Example 1, except that 2-octadecylglutaric acid was used as the electron-accepting compound. The initialization step, recording step, reproduction step and erasing step were performed as in Example 1.

After the aforesaid recording, reproduction and erasure steps were performed 1,000 times, the optical behavior of the recording layer in each step was substantially same as the beginning, and the steps could be performed repeatedly any number of times.

### Example 11

An optical memory device was manufactured exactly as in Example 1, except that p-(octadecylthio)phenol was used as the electron-accepting compound. The initialization step, recording step, reproduction step and erasing step were performed as in Example 1.

After the aforesaid recording, reproduction and erasure steps were performed 1,000 times, the optical behavior of the recording layer in each step was substantially same as the beginning, and the steps could be performed repeatedly any number of times. In Example 11, decolorizing of the PC1 in the semiconductor laser irradiation part in the recording step took about twice as long as in the case of Example 1.

[Example of the Embodiment of the Optical Memory Device (4) and (5)]

EXAMPLE 12

Using 2-[1-(1,2-dimethyl-5-dimethylamino-3-indolyl)ethylidene]-3-isoprop ylidene succinic acid anhydride (hereafter, referred to as PC1) as the photochromic compound, Ni metal complex pigment (PA-1006 manufactured by Mitsui Chemicals, Inc.) (hereafter, referred to as Dl) as infrared absorption agent, docosyl phosphonic acid as the electron-accepting compound and polystyrene as the binder, an optical memory device was manufactured by preparing a coating solution by adding 1 part by weight of D1, 9 parts by weight of docosyl phosphonic acid (melting point 98° C.) and 9 parts by weight of polystyrene to 1 part by weight of PC1 using dihydropyrane as a solvent, casting on a PES (polyethersulfone) substrate to form a recording layer (2 μm), and forming a PVA protection layer (2 μm) and an aluminum reflecting layer (100 nm [1,000 Å]).

<Initialization Step>

When the whole recording layer surface was irradiated by ultraviolet light from the substrate side, the PC1 in the irradiated part colored to give a cyan coloration.

<Recording Step>

Next, when the recording layer was irradiated by a semiconductor laser having a light emission wavelength of 825 nm at an irradiation intensity of 50W/mm² for 1 msec, the recording layer temporarily reached 110° C., and the recording layer turned blue. When part of the recording layer in this state was irradiated by a semiconductor laser having a light emission wavelength of 650 nm, the PC1 in the irradiated part decolorized and became almost colorless. Next, when the recording layer was irradiated by a semiconductor laser having a light emission wavelength of 825 nm at an irradiation intensity of 0.5W/mm² for 20 msec, the recording layer temporarily reached 80° C., and the decolorized part turned pale yellow. Other parts were cyan color.

<Reproduction Step>

When both parts were irradiated by a semiconductor laser having a light emission wavelength of 650 nm, a remarkable difference was seen between them in the intensity of the reflected light. Both parts were then irradiated by the laser having a light emission wavelength of 650 nm for a long time, but in both parts, no change was observed.

<Erasing Step>

Next, both parts were irradiated with ultraviolet light, and as the part with the pale yellow color changed to cyan, the whole became a uniform cyan color.

After the aforesaid recording, reproduction and erasure steps were performed 1,000 times, the optical behavior of the recording layer in each step was substantially same as the beginning, and the steps could be performed repeatedly any number of times.

### EXAMPLE 13

An optical memory device was manufactured by forming a recording layer (2 μm) by casting on a PES (polyethersulfone) substrate as in Example 12 except that, of the component elements of the recording layer of Example 12, D1 was not used. An exothermic layer (2 μm) comprising identical parts by weight of D1 and polycarbonate, and a PVA protection layer (2 μm) and aluminum reflecting layer (100 nm [1000 Å]), were then formed thereupon.

The initialization step, recording step, reproduction step and erasing step were performed as in Example 12.

After the aforesaid recording, reproduction and erasure steps were performed 1,000 times, the optical behavior of the recording layer in each step was substantially same as the beginning, and the steps could be performed repeatedly any number of times.

### EXAMPLE 14

An optical memory device was manufactured as in Example 12.

<Initialization Step>

When this device was irradiated by a semiconductor laser having a light emission wavelength of 825 nm at an irradiation intensity of 50W/mm² for 1 msec, and then irradiated by a red lamp light source, the PC1 was decolorized and became almost colorless.

<Recording Step>

Next, when part of the recording layer in this state was irradiated by ultraviolet light, the PC1 in the irradiated parts turned blue. When the area including the irradiated part was irradiated by a semiconductor laser having a light emission wavelength of 825 nm at 0.5W/mm² for 20 msec, the irradiated part turned to cyan color and the other parts turned pale yellow.

<Reproduction Step>

When both parts were irradiated by a semiconductor laser having a light emission wavelength of 650 nm, a remarkable difference was seen between them in the intensity of the reflected light. Both parts were then irradiated by the laser having a light emission wavelength of 650 nm for a long time, but in both parts, no change was observed.

<Erasing Step>

When the whole surface of the device was irradiated by a semiconductor laser having a light emission wavelength of 825 nm at an irradiation intensity of 50W/mm² for 1 msec, the part which was cyan turned blue, and the pale yellow part became effectively colorless. Next, when both parts were irradiated by a semiconductor laser having a light emission wavelength of 650 nm, the part which was almost colorless showed no change. As the blue part had become almost colorless, both parts became the same. Further, when irradiation was performed by a semiconductor laser having a light emission wavelength of 825 nm at an irradiation intensity of 0.5W/mm² for 20 msec, the almost colorless part turned pale yellow.

After the aforesaid recording, reproduction and erasure steps were performed 1,000 times, the optical behavior of the recording layer in each step was substantially same as the beginning, and the steps could be performed repeatedly any number of times.

### EXAMPLE 15

An optical memory device was manufactured exactly as in Example 12, except that 1,2-bis-(2-methoxy-5-phenyl-3-thienyl)-3,3,4,4,5,5-hexafluorocyclopentene (hereafter, referred to as PC2) was used as the photochromic compound.

<Initialization Step>

When the whole surface of the recording layer was irradiated by ultraviolet light, the PC2 in the irradiated part turned blue.

<Recording Step>

Next, when the recording layer was irradiated by a semiconductor laser having a light emission wavelength of 825 nm at an irradiation intensity of 50W/mm² for 1 msec, the recording layer showed an ultraviolet color. When part of the recording layer in this state was irradiated by a semiconductor laser having a light emission wavelength of 650 nm, the PC2 in the irradiated part was decolorized and became almost colorless. Next, when the recording layer was irradiated by a semiconductor laser having a light emission wavelength of 825 nm at an irradiation intensity of 0.5W/mm² for 20 msec, the part irradiated by the semiconductor laser having a light emission wavelength of 650 nm remained colorless, and other parts turned blue.

<Reproduction Step>

When both parts were irradiated by a semiconductor laser having a light emission wavelength of 650 nm, a remarkable difference was seen between them in the intensity of the reflected light. Both parts were then irradiated by the laser having a light emission wavelength of 650 nm for a long time, but in both parts, no change was observed.

<Erasing Step>

Next, when both parts were irradiated with ultraviolet light, as the colorless parts turned to blue, the whole became a uniform blue color.

After the aforesaid recording, reproduction and erasure steps were performed 1,000 times, the optical behavior of the recording layer in each step was substantially same as the beginning, and the steps could be performed repeatedly any number of times.

### COMPARATIVE EXAMPLE 2

An optical memory device was manufactured essentially as in Example 12, but docosyl phosphonic acid as the electron-accepting compound was omitted from the component elements of the recording layer, and the recording layer was formed by adding 18 parts by weight of polystyrene to 1 part by weight of PC1.

<Initialization Step>

When the whole recording layer surface was irradiated by ultraviolet light from the substrate side, the PC1 in the irradiated part colored to give a cyan coloration.

<Recording Step>

Next, the recording layer was irradiated by a semiconductor laser having a light emission wavelength of 825 nm at an irradiation intensity of 50W/mm² for 1 msec, but the recording layer showed no change. Part of the recording layer in this state was irradiated by a semiconductor laser having a light emission wavelength of 650 nm, but the PC1 in the irradiated part was hardly decolorized and showed no change, so recording could not be performed.

### EXAMPLE 16

An optical memory device was manufactured essentially as in Example 12, but the infrared absorption agent Dl was omitted from the component elements of the recording layer in forming the recording layer.

<Initialization Step>

When the whole recording layer surface was irradiated by ultraviolet light from the substrate side, the PC1 in the irradiated part colored to give a cyan coloration.

<Recording Step>

Next, the recording layer was irradiated by a semiconductor laser having a light emission wavelength of 825 nm at an irradiation intensity of 50W/mm² for 1 msec, but the recording layer showed no change. Part of the recording layer in this state was irradiated by a semiconductor laser having a light emission wavelength of 650 nm, but the PC1 in the irradiated part was hardly decolorized and showed no change, so recording could not be performed.

Thereafter, initialization, recording, reproduction and erasing steps are performed as in Example 1.

<Initialization Step>

When the whole recording layer surface was irradiated by ultraviolet light from the substrate side, the PC1 in the irradiated part colored to give a cyan coloration.

<Recording Step>

Next, the whole surface of the recording layer was heat-treated by a heat roller from the reflecting layer side until it temporarily reached 110° C., and the recording layer turned blue. When part of the recording layer in this state was irradiated by a semiconductor laser having a light emission wavelength of 650 nm, the PC1 in the irradiated part decolorized and became almost colorless. Next, when the whole surface of the recording layer was heat-treated by the heat roller until it temporarily reached 80° C., the semiconductor laser irradiation part turned pale yellow, and the other parts were cyan color.

<Reproduction Step>

When both parts were respectively irradiated by the semiconductor laser, a remarkable difference was observed between the two parts in the intensity of reflected light. Both parts were then irradiated for a long time by the laser light, but no change at all was seen in either part.

<Erasing Step>

Next, both parts were irradiated with ultraviolet light, and as the part with the pale yellow color changed to cyan, the whole became a uniform cyan color.

After the aforesaid recording, reproduction and erasure steps were performed 1,000 times, the optical behavior of the recording layer in each step was substantially same as the beginning, and the steps could be performed repeatedly any number of times.

### EXAMPLE 17

An optical memory device was manufactured exactly as in Example 12, except that a-hydroxytetradecanoic acid was used as the electron-accepting compound. The initialization, recording, reproduction and erasing steps were performed as in Example 12.

After the aforesaid recording, reproduction and erasure steps were performed 1000 times, the optical behavior of the recording layer in each step was substantially same as the beginning, and the steps could be performed repeatedly any number of times. In Example 17, slightly more time was required than in the case of Example 12 to decolorize the PC1 in the part irradiated by the semiconductor laser having a light emission wavelength of 650 nm in the recording step.

### EXAMPLE 18

An optical memory device was manufactured exactly as in Example 12, except that 2-fluoro-octadecanoic acid was used as the electron-accepting compound. The initialization, recording, reproduction and erasing steps were performed as in Example 12.

After the aforesaid recording, reproduction and erasure steps were performed 1,000 times, the optical behavior of the recording layer in each step was substantially same as the beginning, and the steps could be performed repeatedly any number of times. In Example 18, almost twice as long was required than in the case of Example 12 to decolorize the PC1 in the part irradiated by the semiconductor laser having a light emission wavelength of 650 nm in the recording step.

### EXAMPLE 19

An optical memory device was manufactured exactly as in Example 12, except that 2-oxo-octadecanoic acid was used as the electron-accepting compound. The initialization, recording, reproduction and erasing steps were performed as in Example 12.

After the aforesaid recording, reproduction and erasure steps were performed 1,000 times, the optical behavior of the recording layer in each step was substantially same as the beginning, and the steps could be performed repeatedly any number of times. In Example 19, almost twice as long was required than in the case of Example 12 to decolorize the PC1 in the part irradiated by the semiconductor laser having a light emission wavelength of 650 nm in the recording step.

### EXAMPLE 20

An optical memory device was manufactured exactly as in Example 12, except that 2-(octadecylthio)succinic acid was used as the electron-accepting compound. The initialization, recording, reproduction and erasing steps were performed as in Example 12.

After the aforesaid recording, reproduction and erasure steps were performed 1,000 times, the optical behavior of the recording layer in each step was substantially same as the beginning, and the steps could be performed repeatedly any number of times.

### EXAMPLE 21

An optical memory device was manufactured exactly as in Example 12, except that octadecylsuccinic acid was used as the electron-accepting compound. The initialization, recording, reproduction and erasing steps were performed as in Example 12.

After the aforesaid recording, reproduction and erasure steps were performed 1000 times, the optical behavior of the recording layer in each step was substantially same as the beginning, and the steps could be performed repeatedly any number of times. In Example 21, slightly more time was required than in the case of Example 12 to decolorize the PC1 in the part irradiated by the semiconductor laser having a light emission wavelength of 650 nm in the recording step.

### EXAMPLE 22

An optical memory device was manufactured exactly as in Example 12, except that octadecylmalonic acid was used as the electron-accepting compound. The initialization step, recording step, reproduction step and erasing step were performed as in Example 12.

After the aforesaid recording, reproduction and erasure steps were performed 1,000 times, the optical behavior of the recording layer in each step was substantially same as the beginning, and the steps could be performed repeatedly any number of times.

### EXAMPLE 23

An optical memory device was manufactured exactly as in Example 12, except that 2-octadecylglutaric acid was used as the electron-accepting compound. The initialization step, recording step, reproduction step and erasing step were performed as in Example 12.

After the aforesaid recording, reproduction and erasure steps were performed 1,000 times, the optical behavior of the recording layer in each step was substantially same as the beginning, and the steps could be performed repeatedly any number of times.

### EXAMPLE 24

An optical memory device was manufactured exactly as in Example 12, except that p-(octadecylthio)phenol was used as the electron-accepting compound. The initialization, recording, reproduction and erasing steps were performed as in Example 12.

After the aforesaid recording, reproduction and erasure steps were performed 1000 times, the optical behavior of the recording layer in each step was substantially same as the beginning, and the steps could be performed repeatedly any number of times. In Example 24, about twice as long was required than in the case of Example 12 to decolorize the PC1 in the part irradiated by the semiconductor laser having a light emission wavelength of 650 nm in the recording step.

As is clear from the detailed, specific description above, in the first embodiment of the optical memory device according to the present invention, an optical memory device is obtained wherein the decolorizing sensitivity can be reversibly controlled. Also, an optical memory device which is thermally stable, highly durable and wherein recordings are not destroyed by visible light used to read data, is obtained. Various compounds having different electron-accepting properties can be obtained as component elements used in the optical memory device which permits control of decolorizing sensitivity, and enlarge the degree of freedom of material design of the recording layer. The optical memory device has the distinct advantage of physically and chemically offering improved durability. In an information recording mode wherein the whole surface of the device is irradiated by ultraviolet light to color the recording layer, and then irradiated by visible light, the device is first placed in a high decolorizing sensitivity state, and then changed over to a low sensitivity state so that the recording is not destroyed when it is irradiated by visible light for read-out. Alternatively, in an information recording mode wherein the whole surface of the device is irradiated by visible light to decolorize the recording layer and then irradiated by ultraviolet light to record information, an area including the recording part is changed over to a low sensitivity state after recording so that the recording is not destroyed when it is irradiated by visible light for read-out. For erasure, information is erased by temporarily placing the device in a high decolorizing sensitivity state, and then irradiating it by visible light.

In the second embodiment of the optical memory device according to the present invention, an optical memory device is obtained wherein the decolorizing sensitivity can be reversibly controlled by optical irradiation treatment alone. An optical memory device which is thermally stable, highly durable and wherein recordings are not destroyed by visible light used to read data, is obtained. Various compounds having different electron-accepting properties can be obtained as component elements used in the optical memory device which permits control of decolorizing sensitivity, and enlarge the degree of freedom of material design of the recording layer. The optical memory device has the distinct advantage of physically and chemically offering improved durability. In an information recording mode wherein the whole surface of the device is irradiated by ultraviolet light to color the recording layer, and then irradiated by visible light, the device is first placed in a high decolorizing sensitivity state, and then changed over to a low sensitivity state so that the recording is not destroyed when it is irradiated by visible light for read-out. Alternatively, in an information recording mode wherein the whole surface of the device is irradiated by visible light to decolorize the recording layer and then irradiated by ultraviolet light to record information, an area including the recording part is changed over to a low sensitivity state after recording so that the recording is not destroyed when it is irradiated by visible light for read-out. For erasure, information is erased by temporarily placing the device in a high decolorizing sensitivity state, and then irradiating it by visible light.

What is claimed is:

1. An optical memory device comprising:
a recording layer containing a photochromic compound and an electron-accepting compound, disposed above a substrate,
wherein the electron-accepting compound is a Lewis acid compound having a Lewis acid part and a long chain structure part.

2. An optical memory device according to claim 1, wherein the long chain structure part has carbon atoms of 12 or more.

3. An optical memory device according to claim 1, further comprising:
a reflecting layer disposed at least one of on a surface of the recording layer, and between the recording layer and the substrate.

4. An optical memory device according to claim 1, wherein the recording layer further contains an infrared absorption agent.

5. An optical memory device according to claim 4, the infrared absorption agent is at least one of a naphthalocyanine dye, a cyanine dye and a metal complex pigment.

6. An optical memory device according to claim 1, further comprising:
an exothermic layer containing an infrared absorption agent.

7. An optical memory device according to claim 6, wherein the infrared absorption agent is at least one of a naphthalocyanine dye, a cyanine dye and a metal complex pigment.

8. An optical memory device according to claim 1, the photochromic compound is a thermally irreversible photochromic compound.

9. An optical memory device according to claim 8, wherein the thermally irreversible photochromic compound is one selected from a fulgide compound, a diarylethene compound, and a compound including at least one of the fulgide compound and the diarylethene compound in part.

10. An optical memory device according to claim 1, wherein the Lewis acid compound is at least one of a phosphnic acid compound, an aliphatic carboxylic acid compound, and a phenol compound.

11. An optical memory device according to claim 10, wherein the phosphonic compound is a compound expressed by Formula 1:
R¹—PO(OH)₂ Formula 1
where, R¹ expresses a long chain structure having carbon atoms of 12 or more.

12. An optical memory device according to claim 10, wherein the aliphatic carboxylic acid compound is an α-hydroxyaliphatic carboxylic acid compound expressed by following Formula 2:
R²—CH(OH)—COOH Formula 2
where, R² expresses a long chain structure having carbon atoms of 12 or more.

13. An optical memory device according to claim 10, wherein the aliphatic carboxylic acid compound has a long chain structure part having carbon atoms of 12 or more, including an aliphatic group substituted by a halogen atom, where at least one of the carbon atom at α position and the carbon atom at β position is bonded to the halogen atom.

14. An optical memory device according to claim 10, wherein the aliphatic carboxylic acid compound has a long chain structure part having carbon atoms of 12 or more, including an aliphatic group having an oxo group in a carbon chain thereof, where at least one of the carbon atom at α position, the carbon atom at β position, and the carbon atom at γ position is the oxo group.

15. An optical memory device according to claim 10, wherein the aliphatic carboxylic acid compound is a compound expressed by Formula 3: 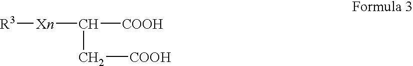
where, R³ expresses a long chains structure having carbon atoms of 12 or more, X expresses one of an oxygen atom and a sulfur atom, when X is an oxygen atom, n is 1, and when X is a sulfur atom, n is 1 or 2.

16. An optical memory device according to claim 10, wherein the aliphatic carboxylic acid compound is a compound expressed by Formula 4: 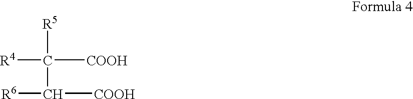
where, each R⁴, R⁵, and R⁶ expresses one of a hydrogen atom and an aliphatic group, and at least one thereof is a long chain structure having carbon atoms of 12 or more.

17. An optical memory device according to claim 10, wherein the aliphatic carboxylic acid compound is a compound expressed by Formula 5: 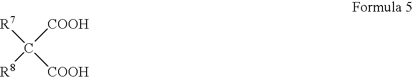
where, each R⁷ and R⁸ expresses one of a hydrogen atom and an aliphatic group, and at least one thereof is a long chain structure having carbon atoms of 12 or more.

18. An optical memory device according to claim 10, wherein the aliphatic carboxylic acid compound is a compound expressed by Formula 6: 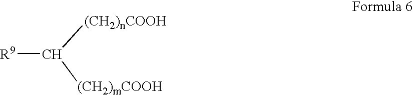
where, R⁹ expresses a long chain structure having carbon atoms of 12 or more, n expresses 0 or 1, m expresses 0.1, 2 or 3, when n is 0, m is 2 or 3, and when n is m is 1 or 2.

19. An optical memory device according to claim 10, wherein the aliphatic carboxylic acid compound is a compound expressed by Formula 7: 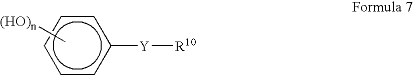
where, Y expresses one of —S—, —O—, —CONH— and —COO—, R¹⁰ expresses a long chain structure having carbon atoms of 12 or more, and n expresses 1, 2 or 3.

20. An optical memory device according to claim 1, further comprising a protective layer.

21. A process for operating an optical memory device, comprising the steps of:
heating a recording layer of an optical memory device, which contains a photochromic compound and an electron-accepting compound, temporarily to a melting point of the electron-accepting compound or higher, irradiating visible light including a wavelength corresponding to an absorption band of the colored photochromic compound, to an area including a recording part of the recording layer so as to decolorize, and then heating the area to a temperature lower than the melting point of the electron-accepting compound; and
irradiating ultraviolet light to an area including the recording part so as to color the photochromic compound,
wherein the optical memory comprises the recording layer above a substrate, and the electron-accepting compound is a Lewis acid compound having a Lewis acid part and a long chain structure part having carbon atoms of 12 or more.

22. A process for operating an optical memory device, according to claim 21, further comprising the step of:
irradiating ultraviolet light to the optical memory device so as to color the photochromic compound for initialization.

23. A process for operating an optical memory device, comprising the steps of:
irradiating ultraviolet light to an area including a recording part of a recording layer of an optical memory device so as to color a photochromic compound contained in the recording layer, and then heating the area to a temperature lower than a melting point of an electron-accepting compound also contained in the recording layer; and
heating the recording layer temporarily to the melting point of the electron-accepting compound or higher, irradiating visible light including a wavelength corresponding to an absorption band of the colored photochromic compound, to an area including the recording part so as to decolorize, and then heating an area including the recording part to a temperature lower than the melting point of the electron-accepting compound,
wherein the optical memory device comprises the recording layer above a substrate, and the electron-accepting compound is a Lewis acid compound having a Lewis acid part and a long chain structure part having carbon atoms of 12 or more.

24. A process for operating an optical memory device according to claim 23, further comprising the step of:
heating the recording layer temporarily to the melting point of the electron-accepting compound or higher, and irradiating visible light including a wavelength corresponding to the absorption band of the colored photochromic compound so as to decolorize the photochromic compound for initialization.

25. A process for operating an optical memory device, comprising the steps of:
irradiating infrared light to a recording layer of an optical memory device, which contains a photochromic compound and an electron-accepting compound, so as to heat the recording layer temporarily to a melting point of the electron-accepting compound or higher, irradiating visible light including a wavelength corresponding to an absorption band of the colored photochromic compound, to an area including a recording part of the recording layer so as to decolorize, and then irradiating infrared light to the area so as to heat the area to a temperature lower than the melting point of the electron-accepting compound; and
irradiating ultraviolet light to an area including the recording part so as to color the photochromic compound,
wherein the optical memory device comprises the recording layer above a substrate, at least one of the recording layer and an exothermic layer contains an infrared absorption agent, and the electron-accepting compound is a Lewis acid compound having a Lewis acid part and a long chain structure part having carbon atoms of 12 or more.

26. A process for operating an optical memory device according to claim 25, further comprising the step of:
irradiating ultraviolet light to the optical memory device so as to color the photochromic compound for initialization.

27. A process for operating an optical memory device, comprising the steps of:
irradiating ultraviolet light to an area including a recording part of a recording layer of an optical memory device so as to color a photochromic compound contained in the recording layer, and then irradiating infrared light to the area so as to heat the area to a temperature lower than a melting point of an electron-accepting compound also contained in the recording layer; and
irradiating infrared light to the recording layer so as to heat the recording layer temporarily to the melting point of the electron-accepting compound or higher, irradiating visible light including a wavelength corresponding to an absorption band of the colored photochromic compound, to an area including the recording part so as to decolorize, and then heating an area including the recording part to a temperature lower than the melting point of the electron-accepting compound,
wherein the optical memory device comprises the recording layer above a substrate, at least one of the recording layer and an exothermic layer contains an infrared absorption agent, and the electron-accepting compound is a Lewis acid compound having a Lewis acid part and a long chain structure part having carbon atoms of 12 or more.

28. A process for operating an optical memory device according to claim 27, further comprising the step of:
irradiating infrared light to the recording layer so as to heat temporarily to the melting point of the electron-accepting compound or higher, and irradiating visible light including a wavelength corresponding to the absorption band of the colored photochromic compound, so as to decolorize the photochromic compound for initialization.
